(19) United States
(12) Patent Application Publication
(10) Pub. No.: US 2023/0376520 A1
(43) Pub. Date: Nov. 23, 2023

(54) SYSTEM AND METHOD FOR MANAGING MULTIMEDIA UPLOAD OF A REPORT USING A VIRTUAL ASSISTANT

(71) Applicant: MOTOROLA SOLUTIONS, INC., CHICAGO, IL (US)

(72) Inventor: ELLIS ALEXANDER PINDER, DAVIE, FL (US)

(21) Appl. No.: 17/663,738

(22) Filed: May 17, 2022

(51) Int. Cl. G06F 16/432; G06F 16/483; G06F 16/48; H04L 51/10; H04L 51/02

(52) U.S. Cl. CPC G06F 16/432; G06F 16/483; G06F 16/489; H04L 51/10; H04L 51/02

(57) ABSTRACT

Techniques for attaching multimedia to a report are provided. A request to attach a multimedia file to a report is received at a virtual assistant. A placeholder associated with the requested multimedia file is inserted in the report. A source of the multimedia file is identified. When the file is not already stored by a multimedia repository, it is requested from the source of the multimedia file that the multimedia file be provided to the multimedia repository to be stored. The placeholder associated with the requested multimedia file is replaced with the multimedia file stored in the multimedia repository once available.

### BACKGROUND

A public safety incident is a broad term that encapsulates almost any type of interaction public safety personnel (e.g. police officers, firefighters, etc.) may have with the public. Public safety incidents can include traffic accidents, crimes, natural disasters, or any other type of event where public safety personnel provide assistance. In general, upon conclusion of a public safety incident, a written report may be created. The written report may include a written description of the incident, which is sometimes referred to as an incident narrative. The report may also include information such as the location and time of the incident, participants (including both victims and suspects), identities of responding personnel, equipment present, etc.

In addition to the written description of an incident, the report may also have multimedia files attached. The presence of recording devices in the modern public safety environment has become ubiquitous. Many, if not most, public safety vehicles are equipped with cameras, such as dashboard cameras. Police officers may also carry body worn cameras (BWC) that capture portions of the incident. Municipalities may deploy monitoring cameras for many different purposes, such as traffic management and those cameras may capture footage associated with the incident. Furthermore, there may be private camera sources that capture the incident. For example, a business may have deployed security cameras for business purposes (e.g. theft prevention, parking lot security, etc.). Private individuals may also deploy cameras (e.g. doorbell cameras, etc.) for personal security. All of these multimedia capturing devices may have recorded at least portions of a public safety incident.

What should be understood is that supplementing the written, textual narrative of a public safety incident with recorded multimedia (e.g. video, etc.) of the incident scene may be very beneficial for someone who is later reading the incident report and trying to understand what occurred. For example, in the case of a traffic accident, the narrative may read, “the driver's line of sight was obscured by overgrown bushes,” is open to interpretation. An actual video (e.g. taken by a BWC) of the driver's line of sight would make it much more clear to the report reviewer the exact degree to which the line of sight was blocked. The adage that a picture is worth a thousand words may be even more true in today's world with the ubiquitous presence of multimedia capture devices.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments

FIG. 1 is an example of a hypothetical incident environment for which a report is being generated.

FIG. 2 is a block diagram of an example system that may implement the multimedia management techniques described herein.

FIG. 3 is an example flow diagram of an implementation of the multimedia management techniques described herein.

FIG. 4 is an example of a computing device that may implement some or all of the techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

As should be clear, the inclusion of multimedia files as attachments to a written incident report is highly beneficial to a later reviewer of the report. The multimedia files may allow the reviewer to gain a much better understanding of what actually transpired during the incident.

A problem arises in that at the time of writing the report, the multimedia files may not be readily available in a repository for easy attachment to the report. For example, in the case of a police dashboard camera or officer BWC, the recorded multimedia may be uploaded to a central agency repository at the end of the officer's shift (e.g. when the officer returns to the station, etc.). Accordingly, the multimedia file may not be available for attachment to the report while the report is being written.

In some cases, the multimedia file may be uploaded to a central repository of another agency. For example, consider a case where both the local police and a county sheriff (i.e. a different agency) have responded to an incident scene. Both the local police and sheriff officers may have a BWC. At the end of their shift, each agency officer may upload the multimedia files to their respective agencies central repository. If the local police officer is writing a report, and wishes to include the BWC footage of the sheriff's officer, the multimedia file must first be requested from the other agency. Further exacerbating the problem is that each agency may refer to the multimedia files using different naming conventions. As a simple example, the local agency may name files using the officer's last name, followed by a date whereas the sheriff agency may use the date followed by the officer's name. Although resolution of such discrepancies may be trivial for a human, it is much more difficult to provide a programmatic solution.

The problem of locating multimedia files for attachment to reports is even further exacerbated when dealing with private sources of multimedia. Public safety agencies may work with other agencies on a regular basis. As such, policies and procedures may be in place that allow one agency to efficiently interact with another agency. In contrast, there may not be an established relationship between owners of private multimedia capture devices (e.g. businesses with security cameras, individuals with doorbell cameras, etc.). As such, a request for a multimedia file from such a privately owned camera may utilize an ad-hoc procedure for obtaining the multimedia file.

The techniques described herein address these problems and others, individually and collectively. A report writer may use a reporting writing device (e.g. laptop computer, tablet, etc.) in order to write up an incident report. A virtual assistant may be associated with the report writer to receive requests to attach a multimedia file to the report. In one example implementation, the report writer may interact with the virtual assistant using natural language and request attachment of a multimedia file using colloquial language. For example, assume the wake word associated with the virtual assistant is “Hey ViQi.” The report writer, while writing the report may say, “Hey ViQi, please attach the video from my dashboard camera between 3:00 PM and 3:15 PM today.” The virtual assistant may then place a marker, or placeholder, in the report where the requested multimedia file can be attached. The report writer can then continue writing the report, including making additional requests for attachment of multimedia files.

The virtual assistant may then interact with a mapping service, which associates multimedia sources to retrieval procedures. As mentioned above, the request for attachment of a multimedia file may be made using colloquial speech. The mapping service may translate the colloquial request into a request that is more directly usable by the system in retrieving the specified multimedia file. For example, the mapping service could determine the file is available in a local repository and provide a mapping to a particular storage location, file name, etc. As another example, the mapping service may determine the file is located in the storage of another agency, and may map the request to the format used by the other agency (e.g. external agencies naming convention, etc.). In some cases, the mapping service may not know how to retrieve the requested multimedia file. In such cases, the request may be sent to a human operator for manual intervention. The amount of times manual intervention is required to retrieve a multimedia file from a certain source (e.g. doorbell camera service, etc.) may indicate that a programmatic application programming interface (API) for such retrieval should be developed in order to reduce the number of times the mapping service needs to request manual intervention.

Once the mapping service has determined where the multimedia file can be retrieved from (or has requested manual intervention), the multimedia file may be retrieved from the storage location and stored in a multimedia repository. Once the multimedia file is available in the multimedia repository (e.g. has been retrieved from wherever the file was stored), the virtual assistant may cause the multimedia file to be inserted into the report at the location of the marker, or placeholder, that was previously inserted into the report. Once the requested multimedia files have been attached, the report writer may be notified that the report is now complete with all requested multimedia files having been attached.

This advantageously frees the report writer from having to manually locate and attach every requested multimedia file. Furthermore, it frees the report writer from having to know the specific storage location and naming convention for every possible source of multimedia files. In addition, it frees the report writer from having to constantly check if a particular multimedia file has been uploaded to a multimedia repository and is now available for attachment. Instead, the virtual assistant simply notifies the report writer once the multimedia file has been attached.

A method for attaching multimedia to a report is provided. The method includes receiving, at a virtual assistant, a request to attach a multimedia file to a report. The method also includes inserting a placeholder associated with the requested multimedia file in the report. The method also includes identifying a source of the multimedia file. The method also includes requesting, from the source of the multimedia file, that the multimedia file be provided to a multimedia repository to be stored, when the multimedia file is not already stored by the multimedia repository. The method also includes replacing the placeholder associated with the requested multimedia file with the multimedia file stored in the multimedia repository once available.

In one aspect, the method includes determining the source of the multimedia file is an external agency and converting the request for the multimedia file to a format understood by the external agency. In one aspect, the method includes determining the source of the multimedia file is an external agency, determining there is not an automated process for requesting the multimedia file from the external agency, initiating a manual process to request the multimedia file from the external agency, and converting the manual process to request the multimedia file from the external agency to an automated process, wherein subsequent requests for multimedia files from the external agency utilize the automated process.

In one aspect, the method includes determining if the request to add the multimedia file is ambiguous and requesting clarification for the ambiguous request. In one aspect, the method includes converting the request for the multimedia file to a specific multimedia capture device that captured the requested multimedia file. In one aspect, the request for the multimedia file includes a time range. In one aspect, the request for the multimedia file includes spatial information.

A system is provided. The system includes a processor and a memory coupled to the processor. The memory contains a set of instructions thereon that when executed by the processor cause the processor to receive, at a virtual assistant, a request to attach a multimedia file to a report. The instructions also cause the processor to insert a placeholder associated with the requested multimedia file in the report. The instructions also cause the processor to identify a source of the multimedia file. The instructions also cause the processor to request, from the source of the multimedia file, that the multimedia file be provided to a multimedia repository to be stored, when the multimedia file is not already stored by the multimedia repository. The instructions also cause the processor to replace the placeholder associated with the requested multimedia file with the multimedia file stored in the multimedia repository once available.

In one aspect the instructions further cause the processor to determine the source of the multimedia file is an external agency and convert the request for the multimedia file to a format understood by the external agency. In one aspect the instructions further cause the processor to determine the source of the multimedia file is an external agency, determine there is not an automated process for requesting the multimedia file from the external agency, initiate a manual process to request the multimedia file from the external agency, and convert the manual process to request the multimedia file from the external agency to an automated process, wherein subsequent requests for multimedia files from the external agency utilize the automated process.

In one aspect the instructions further cause the processor to determine if the request to add the multimedia file is ambiguous and request clarification for the ambiguous request. In one aspect the instructions further cause the processor to convert the request for the multimedia file to a specific multimedia capture device that captured the requested multimedia file. In one aspect, the request for the multimedia file includes a time range. In one aspect, the request for the multimedia file includes spatial information.

A non-transitory processor readable medium containing a set of instructions thereon is provided. The instructions that when executed by a processor cause the processor to receive, at a virtual assistant, a request to attach a multimedia file to a report. The instructions also cause the processor to insert a placeholder associated with the requested multimedia file in the report. The instructions also cause the processor to identify a source of the multimedia file. The instructions also cause the processor to request, from the source of the multimedia file, that the multimedia file be provided to a multimedia repository to be stored, when the multimedia file is not already stored by the multimedia repository. The instructions also cause the processor to replace the placeholder associated with the requested multimedia file with the multimedia file stored in the multimedia repository once available.

In one aspect, the instructions on the medium further cause the processor to determine the source of the multimedia file is an external agency and convert the request for the multimedia file to a format understood by the external agency. In one aspect, the instructions on the medium further cause the processor to determine the source of the multimedia file is an external agency, determine there is not an automated process for requesting the multimedia file from the external agency, initiate a manual process to request the multimedia file from the external agency, and convert the manual process to request the multimedia file from the external agency to an automated process, wherein subsequent requests for multimedia files from the external agency utilize the automated process.

In one aspect, the instructions on the medium further cause the processor to determine if the request to add the multimedia file is ambiguous and request clarification for the ambiguous request. In one aspect, the instructions on the medium further cause the processor to convert the request for the multimedia file to a specific multimedia capture device that captured the requested multimedia file. In one aspect, the request for the multimedia file includes a time range.

Further advantages and features consistent with this disclosure will be set forth in the following detailed description, with reference to the figures.

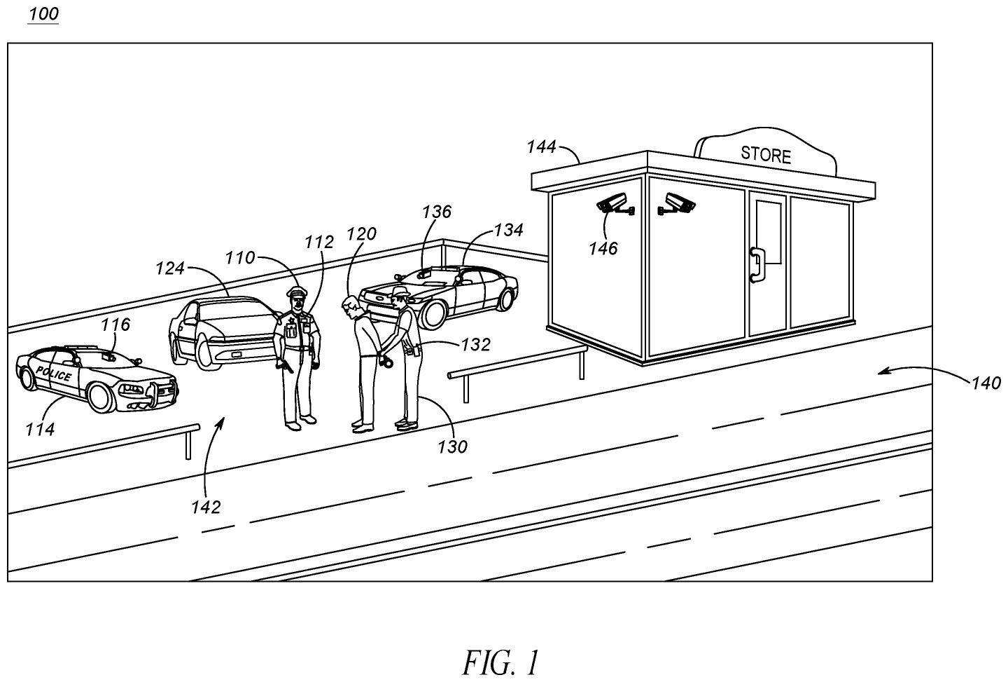

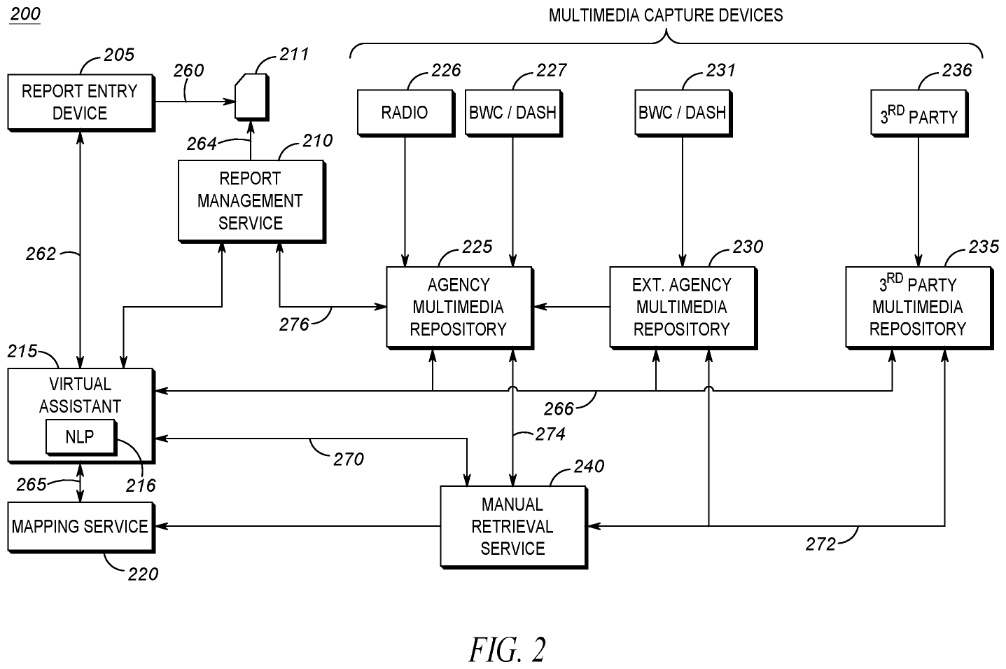

FIG. 1 is an example of a hypothetical incident environment 100 for which a report is being generated. The environment 100 may include a police officer 110 who is equipped with a BWC 112 that may be utilized to record the police officer's surroundings. The police officer 110 may also have a police car 114 in which the police officer conducts patrols and other activities. The police car 114 may also include a dashboard camera 116 that may be utilized to record what is seen through the front windshield of the police car. Although the dashboard camera is described as capturing the scene through the windshield of the police car 114, it should be understood that a dashboard camera is intended to describe any in-vehicle mounted camera. Actual in-vehicle cameras may capture what is occurring in front of the police car, behind the police car, on either side of the police car, or in the interior of the police car. As will be described in further detail with respect to FIG. 2, the police officer may also be associated with a virtual assistant (not shown in FIG. 1) that may receive requests to attach multimedia files to an incident report.

The environment 100 may also include an arrestee 120. As will be explained in further detail below, arrestee 120 may be suspected of some crime and is being arrested by police officer 110. The arrestee 120 may have been driving in a suspect vehicle 124. The environment 100 may also include a sheriff's officer 130. Just as with the police officer 110, the Sheriff's officer 130 may also be equipped with a BWC 132. The Sheriff's Officer 130 may also drive a Sheriff's car 134 that is equipped with a dashboard camera 136. As should be clear, the police officer 110 and Sheriff's officer 130 are both law enforcement agents, but for purposes of this hypothetical report to different law enforcement agencies.

Environment 100 may also include a road 140, which may be referred to as main street. The road 140 may be adjoined to a parking lot 142. A store 144, which has been named the “ABC Store” may be a business within the parking lot 142. The store 144 may be equipped with a surveillance camera 146 that may have a field of view including parking lot 142.

For purposes of this hypothetical, assume police officer 110 is driving police car 114 down Main Street 140. Suspect vehicle 124 is in front of police car 114 and is driving erratically (e.g. crossing center line, failing to maintain lane position, etc.), which may be indicative of a drunk driver. Police officer 110 may pull over suspect vehicle 124 into parking lot 142. The police officer 114 may conduct a field sobriety test on arrestee 120, who is driving suspect vehicle 124. Police officer 110 may determine that arrestee 120 has failed the field sobriety test, and desires to place arrestee 120 under arrest.

Assume department procedures require two officers be present whenever an arrest is being made and the Sheriff's officer 130, although being in a different agency, is the closest officer available to provide backup to police officer 110. Furthermore, in the present hypothetical, assume that the arrestee 120 resists being placed under arrest which then required police officer 110 and sheriff's officer 130 to use physical force to effectuate the arrest.

When the incident is concluded, which for purposes of this hypothetical is when the arrestee 120 is placed in the back of the police car 114, the police officer 110 may write an incident report. As explained above, the incident report is a textual description, or narrative, of what occurred during the incident. In the following paragraphs, text that is entered by the police officer as part of the narrative, will be enclosed in { } curly brackets, whereas requests to the virtual assistant for attaching multimedia files, such as video captured from the various cameras describe, will be enclosed in “ ” quotation marks.

It should further be understood that although the incident report creation process is described as the police officer 110 typing in the narrative, while speaking requests to the virtual assistant, this is merely by way of example. The report text can be created by any other means, such as speech to text conversion, etc. Likewise, requests to the virtual assistant could be typed. What should be understood is that the police officer provides the narrative and makes requests to the virtual assistant to attach multimedia files.

Begin Incident Report Creation

{I, Officer John Doe, was driving down Main Street at approximately 3:05 PM, on Apr. 18, 2022. I noticed a suspicious vehicle in front of me that was crossing the center line, and failing to maintain lane position. I suspected the driver of the vehicle may be impaired.} “Hey ViQi, attach the front view of my dashboard camera from today, between 2:55 PM and 3:10 PM.” {I proceeded to turn on my overhead police lights to attempt a vehicle stop. The suspect vehicle turned into the parking lot of the ABC Store, which is located at 123 Main Street. I asked the driver to exit the vehicle and performed a roadside sobriety check on the suspect. The suspect failed the test, the entirety of which was captured on my body worn camera.} “Hey ViQi, attach my body worn camera video from the time I pulled the vehicle over, to when the incident was completed.”

{I then made the decision to arrest the suspected impaired driver based on the failed sobriety test. In accordance with department policy, I requested a backup officer to aid in the arrest. Sheriff's officer Tom Smith was the nearest available backup, and arrived on scene at approximately 3:15 PM. Upon Officer Smith's arrival, the suspect broke free and began running around the parking lot.} “Hey ViQi, attach the camera video from the ABC Stores parking lot surveillance camera, starting at 3:10 PM.” {Officer Smith and I then proceeded to use authorized physical force to restrain the suspect and place him under arrest.} “Hey ViQi, attach the body worn camera video from Sheriff's officer Tom Smith, starting at 3:15 PM.”

End Incident Report Creation

What should be clear is that the officer creating the incident report describes the incident as would normally be done. When the description would be better understood by the inclusion of a multimedia file, the officer requests that the virtual assistant attach the file. For example, when the officer 110 states that the suspect vehicle was crossing the centerline and failing to maintain lane position, the view from the front facing dashboard camera 116 of his police car 114 would be compelling evidence to show the erratic driving. The same applies to all other requests for the attachment of multimedia files.

As will be explained in further detail below, the virtual assistant may simply include a placeholder in the incident report whenever attachment of a multimedia file is requested. As explained above, the multimedia files may not be readily available and may require some time to be acquired. The techniques described herein allow the officer to simply request that a file be attached and the virtual assistant takes care of the necessary steps to obtain the file and attach it to the incident report. It should be noted that in some cases, the request for attachment of a multimedia file may not be successfully completed. For example, the mapping service, described below, may not be able to resolve a request for a multimedia file. In such a case, the officer may be asked for additional clarifying details as to the file they wish to attach.

What should be understood is that the officer need not manually obtain multimedia files to attach to the report. The officer need only wait until the virtual assistant, or report management entity, informs the officer that all requested multimedia files have been obtained and attached or the request has otherwise been completed (e.g. request could not be resolved).

FIG. 2 is a block diagram of an example system 200 that may implement the multimedia management techniques described herein. System 200 may include multiple devices, such as report entry device 205, multimedia capture devices 226, 227, 231, 236, agency multimedia repository 225, external agency multimedia repository 230, and 3^{rd} party multimedia repository 235. In addition, system 200 may include multiple functions, such as a report management service 210, a virtual assistant 215, a mapping service 220, and a manual retrieval service 240.

The report entry device 205 may be any type of device that a public safety officer may use to enter an incident report. Some example report entry devices may include a desktop or laptop computer, a smartphone, a text to speech conversion device, a tablet, a personal digital assistant (PDA), or any other devices that may be used to create an incident report 211. Typically, a public safety officer will describe an incident in his own words, and enter such description via a keyboard or other such input device. The techniques described herein are not dependent on any particular type of report entry device 205.

Multimedia capture device may be devices that are capable of capturing any form of multimedia. One common form of multimedia capture device is a camera that may record video and audio. Other multimedia capture devices may capture only video or only audio. The techniques described herein are not intended to be limited to any particular type of multimedia capture device. Any device that captures multimedia to a file, whether it be audio, video, documents, or any other type of file, would be suitable for use with the techniques described herein. What should be understood is that the multimedia capture devices capture information in the form of a file that can be attached to a report 211.

A public safety officer within a given agency may carry upon his person or in a vehicle associated with the officer several different types of multimedia capture devices. One example is the police officers radio 226 (e.g. walkie-talkie) over which the officer may communicate via audio. The audio communications received over a radio 226 may be captured in a file. Another type of multimedia capture device may be a body worn camera or a dashboard camera 227, which captures audio/and video of the public safety officer environment. Each of these types of devices may capture audio and/or video information in files that are stored in an agency multimedia repository 225.

The agency multimedia repository 225 may store all multimedia files generated by all members of a public safety agency. Although only a single public safety officer associated with an agency is described, it should be understood that all multimedia files produced by all officers within an agency may be stored within the agency multimedia repository 225. Although the agency multimedia repository is shown as a single element, this is for ease of description, and is not intended to imply that a single system or database stores all multimedia files for a given agency. Instead, it is a logical concept, and the actual storage facilities may be spread across one or more systems or located locally or in the cloud. The agency multimedia repository may store multimedia files using a schema that is well defined. For example, the naming convention for BWC files may be such that a particular BWC video from a specific officer on a specific date can easily be found within the agency multimedia repository 225.

In some incidents, a response may be performed by multiple agencies. In the hypothetical described with respect to FIG. 1 both a police agency and a Sheriff agency (e.g. an external agency) responded to the incident. Officers from an external agency may also be associated with multimedia capture devices. As shown, BWC/Dash camera 231 may be similar to BWC/Dash camera 227, with the exception that it is associated with an external agency (e.g. Sherriff agency).

External agency multimedia repository 230 may be very similar to agency multimedia repository 225 with the exception that it stores multimedia files from an external agency. Although only a single external agency multimedia repository 230 is shown, it should be understood that there may be at least as many external agency multimedia repositories as there are external agencies. External repository 230 similarly is a logical representation for an external agency, with repository 230 physically being realized as one or more local and/or cloud services. Just as with repository 225, external agency multimedia repository 230 may store multimedia files using a naming/storing convention that allows for efficient retrieval of multimedia files. It should be understood that the naming conventions used by the agencies need not, and are likely not, the same. Thus, knowing the naming convention used by one agency does not mean the file retrieval from an external agency can be performed using the same retrieval techniques.

As mentioned above, there may also be 3^{rd} party multimedia capture devices 236. Such devices may include privately owned multimedia capture devices (e.g. private security cameras, cell phone cameras, etc.). The multimedia files captured by these 3^{rd} party devices 236 may be stored in 3^{rd} party multimedia repository 235. However, unlike agency repositories 225, 230, third party repositories may exist for each capture device. For example, for private security cameras, each building with cameras may have its own repository. Likewise, for cell phone cameras, each camera may act as its own repository. Also, unlike agency repositories, there may not be a consistent naming and storage convention used, which may make retrieval from 3^{rd} party repositories a bit more challenging.

Report management service 210 may be a computing module that supports the creation of incident reports 211. A public safety officer, using their report entry device 205, may begin to create an incident report 211. As explained above, and as will be explained in more detail below, the public safety officer may request, from a virtual assistant 215, that a multimedia file that would aid in understanding of the report, be attached to the report. The report management service 210 may then include a placeholder in the report 211. Once the requested multimedia file is available from the agency multimedia repository 225, the report management service 210 may attach the requested multimedia file to the report. Once all requested multimedia files have been attached, the public safety officer who created the report may be notified that the report is complete.

The virtual assistant 215 may be a digital assistant that the public safety officer interacts with in order to request attachment of a multimedia file to a report 211. The public safety officer may first wake up the virtual assistant with a wake word or phrase, such as, “Hey ViQi” which causes the virtual assistant to begin listening for commands to attach a multimedia file. The public safety officer may request attachment of a file using colloquial language, as opposed to the naming convention that is used by the various repositories 225, 230, 235. For example, the public safety officer may say, “Hey ViQi, attach my body camera footage from today between the hours of 2 and 3 PM” rather than having to use a request that directly invokes the naming convention utilized by the storage repositories.

The Virtual Assistant 215 further includes Natural Language Processing subsystem 216 which performs some processing on the colloquial request to resolve it to a more standardized form before passing it on to the mapping service. Those skilled in the art will recognize that NLP systems may use contextual information or other accessible information to complete a request on behalf of a user. For example, a command referencing a BWC may need to identify a BWC's Unit ID to ultimately complete a request for video. While a voice command including “BWC 15217” may be perfectly acceptable, it is likely easier to refer to “my BWC” (the user's own BWC) or “Officer Bart Johnson's BWC” (to reference the BWC assigned to Officer Johnson). In this example, the NLP subsystem 216 of virtual assistant 215 understood the colloquial language “my BWC” and was able to resolve it to a standard form “BWC 15217” by accessing additional information. Similarly, “Officer Bart Johnson”, another officer, may resolve to “BWC 17004”.

Another useful aspect of NLP and its use of contextual information is disambiguation. Suppose that a request for “Officer Smith's BWC video” has been made but there are two different people named “Smith” within the agency. The NLP subsystem 216 would recognize “Officer Smith” as a person and further recognize the description to be ambiguous. The NLP subsystem 216 may ask for a full name, or it may provide a list of people whose last name is “Smith” for the user to choose.

Once a standardized form is available, the Virtual Assistant 215, uses mapping service 220, which understands the process—the where and how—to access the data. This may include server name and address, security credentials, and the command format to access or retrieve the data. The command format may further include opcode or an API, and may also include a means to specify a specific device, a specific file, or a time slice of a specific file. As mentioned previously, the process for retrieving multimedia from different repositories is likely to be different.

If the mapping service has an entry for the multimedia source, the mapping service 220 shall return the specific request and any associated access information to allow the Virtual Assistant 215 to initiate the retrieval process. If the mapping does not have an entry for a multimedia source, then it is not be able to fulfill the request because it lacks information for a particular repository. More concretely, the mapping service has not been appropriately configured to understand how to access data in a specific repository. For example, if the request is to retrieve the parking lot camera footage from the ABC store 146, but the mapping service 220 is not configured to understand what the ABC store is or where its files are associated, the actionable request cannot be generated. Instead, when the mapping service 220 is unable to determine how to retrieve a requested multimedia file, the request may be forwarded to a manual retrieval service 240.

The manual retrieval service may be operated by a human being. The colloquial request for attachment of the multimedia file may be analyzed by the human to determine where the multimedia file can be retrieved from (e.g. 3^{rd} party multimedia repository 235, etc.). The human may then engage in a manual process (e.g. phone calls, emails, etc.) to the source of the requested multimedia file (e.g. the owner of the BAC store 142, etc.) in order to cause the requested file to be stored in the agency multimedia repository 225.

In operation, a public safety officer may begin creation 260 of an incident report 211 using a report entry device 205. Whenever the public safety officer wishes to include a multimedia file in the report 211, they may make a request 262 to the virtual assistant 215 using colloquial language. For example, the officer may say, “Hey ViQi, please attach my body worn camera footage from today, between the hours of 2 and 3 PM.” At the time of the request, the report management service 210 may insert a placeholder 264 within the report 211. As will be explained in further detail below, once the multimedia file is available in the agency multimedia repository, the file will be attached to the report 211.

The virtual assistant 215 may then pass 265 the colloquial request 262 to a mapping service 220 after it has been converted to a standard form by the NLP system 216. The mapping service 220 may determine if the standardized request is suitable for automatic retrieval of the requested multimedia file (i.e. the standardized request is included as an entry in the mapping service). In the case of a multimedia capture device that is associated with the agency 226, 227, the mapping service 220 will be aware of the location and naming convention of the requested file. The same will be true of any other multimedia repositories from the mapping service 220 has already been configured to access. If the virtual assistant 215 is able to determine where the multimedia file is located from the colloquial request, but the specific file reference is ambiguous, the virtual assistant 215 may request further clarification from the multimedia file requestor.

If the mapping service 220 determines the multimedia file was produced by a multimedia capture device associated with the agency (e.g. Radio 226, BMC/Dash 227) the details for retrieving the multimedia file from the agency multimedia repository 225 are provided 264 to the virtual assistant. Likewise, if the multimedia file is located in a repository outside of the agency (e.g. repository 230, 235), the details needed to retrieve that multimedia file from the correct storage repository are provided 264 to the virtual assistant 215.

In the case where the multimedia file is stored in a repository not controlled by the agency, the virtual assistant 215 may request 266 that the external repository store the file in the agency multimedia repository. The request 266 includes the details for retrieving the multimedia file that were determined by the mapping service 220. For example, the virtual assistant may provide a mechanism whereby the external repository can upload the requested multimedia file to the agency multimedia repository. As another example, the virtual assistant may itself directly download the multimedia file to the agency multimedia repository. The specific mechanism of retrieving the multimedia file is unimportant. What should be understood is that the multimedia file is eventually stored in the agency multimedia repository.

In some cases, the mapping service 220 may not be able to programmatically determine how to retrieve the requested multimedia file. In such cases, the virtual assistant 215 may send a request 270 to a manual retrieval service 240 that is operated by a human. The human may interact manually (e.g. phone calls, emails, etc.) 272 with the owners of the external repositories in order to identify the specific multimedia files that are being requested from the colloquial request. Through this manual process, the requested multimedia files from the external repositories may be stored 274 in the agency multimedia repository 225.

The virtual assistant 215 may then monitor 266 the agency multimedia repository 225 to determine when the requested file is available in the repository. For example, in the case of agency multimedia capture devices, files may only be uploaded at the end of a shift. In the case of external repositories, it may take some time for the multimedia file to be uploaded to the agency multimedia repository 225. Although it has been described as monitoring the agency multimedia repository 225, in other implementations the agency multimedia repository may notify the virtual assistant 215 when the requested file is available. What should be understood is that the virtual assistant 215 becomes aware that the requested file is now available.

Once the virtual assistant 215 knows that the requested file is available in the agency multimedia repository 225, the virtual assistant may notify 276 the report management service 210. The report management service 210 may then cause the requested file to be attached to the report. It should be understood that attaching the file does not necessarily mean embedding the file into the report 211. In some cases, attaching the report may include inserting a link to access the file into the report. What should be understood is that the requested multimedia file is easily accessible from the report itself, rather than need to access an external system. Once all requested files have been attached, the report creator is notified that the incident report is complete.

As briefly mentioned above, the mapping service 220 includes the functionality to transform the request for attachment of a file into an actionable request for retrieval of a specific file, or portion of a file, from an agency or external multimedia file repository. When requesting a multimedia file to be attached to a report, there are generally three possibilities as far as the source of the multimedia file. A first possibility is that the file may be stored in a multimedia repository associated with the agency that is creating the report (e.g. agency multimedia repository 225). The second possibility is that the file is located in a multimedia repository that is not directly associated with the agency writing the report, but that can be programmatically accessed (e.g. external agency multimedia repository 230). A third possibility is that the multimedia file is located in a repository that the mapping service is not aware of (e.g. 3^{rd} party multimedia repository 235). In such a case, the retrieval process may be transitioned from an automatic process to a manual retrieval 240. Each of these cases are addressed below.

In the first possible case, the multimedia capture devices 226, 227 are associated with the agency that has implemented the virtual assistant 215. In such a case, the multimedia files are stored in an agency multimedia repository 225 that is also under control of the agency. As such, the virtual assistant 215 has relatively unfettered access to the repository 225 (because presumably all entities within a single agency are entitled to some degree of trust). More importantly, however is that because the officer using the virtual assistant 215 to create the report belongs to the agency, the colloquial reference to the requested multimedia file should conform to the language used by the agency.

For example, the officer may request, “my body worn camera footage” meaning that the officer would like to attach the body worn camera footage from the BWC that he is currently assigned to. The virtual assistant 215/mapping service 220 would know which officer is making the request (e.g. the officer name, badge number, etc.) because that officer would have been logged into the virtual assistant. Once the pronoun “my” has been associated with a specific officer within the agency, another data lookup could occur to identify the exact physical BWC is currently associated with the officer. For example, the BWC may be identified by serial number. Thus, the colloquial phrase, “my body worn camera” could be translated to an exact device identifier. In some cases, if a reference is made to a device, without any type of source identifier (e.g. “attach todays body worn camera footage”) the virtual assistant may assume that the officer meant the footage of the BWC that is associated with the file requestor.

The footage from the body worn camera may be stored in the agency multimedia repository follow a certain naming convention, such as device serial number-date-time. If the officer requested BWC footage from today, the file that begins with the serial number of the camera associated with the officer on today's date could be retrieved. If the request is further narrowed by time, the appropriate file including the specified time range specified could be selected, and possible cropped to only include the specific time rage requested.

Alternately, the external system may use a private naming and storage convention which are hidden; only an external facing API is provided. For example, the external system may use a database and the API permits a database query using a published format.

The body worn camera multimedia capture device is only one example. Other example multimedia capture device may also include a spatial component. For example, as dash board camera may capture video from multiple angles (e.g. front view, left and right side views, in car view, etc.). As part of the colloquial request, a specific spatial reference may be made. For example, the officer may request to “attach my dash board camera front facing view footage.” As above, the phrase “my dash board camera” could be converted to a specific device associated with the officer. The phrase “front facing view” could then be converted to a specific field of view captured by that specific camera.

Although two examples of agency associated devices have been presented, it should be understood that this is only for ease of description. The techniques described are applicable to any type of agency multimedia capture device. The general steps followed would be to convert the colloquial request to a format that is understood by the agency multimedia repository and then retrieve the requested file or portion of the file.

The second possibility is that the multimedia file is located in a multimedia repository of an external agency 230. In many cases, public safety agencies interact with each other often enough that an API may be in place to allow an agency to directly access an external agencies multimedia repository.

As an initial matter, the external agency may not allow access to its multimedia repository by random individuals. If there is an agreement between agencies, some type of authorization process may be put in place to ensure that only authorized requests are honored. The authorization process may be as simple as a username and password or can be more complex, such as those involving authentication certificates. Regardless of the techniques used, the virtual assistant 215 may need to be authorized to access an external agency multimedia repository.

The multimedia retrieval process may then similarly follow the same process described above with respect to retrieving multimedia from within the agency. The main exception being that the external agency may not necessarily use the same naming convention as the initiating agency. For example, the initiating agency may store body worn camera footage by camera serial number, while the external agency may store the footage by officer name. The virtual assistant may need to be configured to understand the naming convention use by the external agency. In some cases, the API may abstract the actual naming convention used by the external agency, and instead provide a published format used to request multimedia files, which the API then converts to the naming convention used by the external agency. Such an abstraction would relieve the virtual assistant from needing to be made aware of any changes in naming convention used by any external agency.

In addition, the virtual assistant 215 may need to understand the device references used by the external agency. For example, with the agency, reference to the front facing view of the dash camera may simply be, “dashboard camera, front view” while the external agency may use a different identification. For example, the eternal agency may refer to the front facing view as view 1, so a request would be, “dashboard camera, view 1.” The virtual assistant would then convert the colloquial terminology used by the agency to standard terminology, which may then be converted by the mapping service 220 to repository specific terminology used by the external agency to reference the specific multimedia file that is being requested. In some cases, the virtual assistant may not be able to automatically access the external agency system directly. For example, there may be a new type of device or the external agency may have changed the naming convention used for identifying devices. For example, the front view of a dashboard camera may be changed to be referenced by “forward view” or an officer last name may be ambiguous as it refers to multiple officer with the same last name. In such cases, the system may revert to a manual retrieval process 240 described in further detail below.

The manual retrieval process, once complete, may inform the mapping service that the request could not be resolved and the reason why. The mapping service can then use this feedback to improve its own performance. For example, if the reason for the automatic process failing was that “view 1” is no longer a valid colloquial reference as it cannot be converted to a standard reference, the NLP 216 of the virtual assistant can be modified to use the currently valid standard reference for view 1.

The third possibility is that the multimedia file is located in a repository that the mapping service is not aware of (e.g. 3^{rd} party multimedia repository 235). In such a case, the system initially becomes a manual system. A human agent is assigned the request for retrieving the multimedia file. The agent may then go through manual processes (e.g. web searches, phone calls, emails, etc.) to identify the owner of the requested multimedia file and to manually request the multimedia file. If there are multiple requests from a new repository, or if future requests from a new repository are deemed likely, then the human agent can modify the mapping service by adding additional detail to enable access and proper retrievals of the new repository. Access to a new repository may likely involve programmatic and security-related activities.

In some cases, the manual processes may be a one-off process to retrieve a specific multimedia file (e.g. from the ABC store 144 parking lot camera 146, etc.) and it does not make sense to develop an automated process for handling such request. However, in some cases, it may be determined that the manual retrieval process 240 is being executed very often for a particular source of multimedia capture devices. For example, consider the case of a convenience store located in close proximity to a high crime area. The convenience store may include a surveillance camera whose footage is constantly being requested.

Instead of constantly going through the manual retrieval process, and automated retrieval process (just as with external public safety agencies) may be set up. Previous interactions with the manual process (e.g. human manually retrieving the requested files) could be used to guide the mapping service into configuration for retrieval of the files from the convenience store.

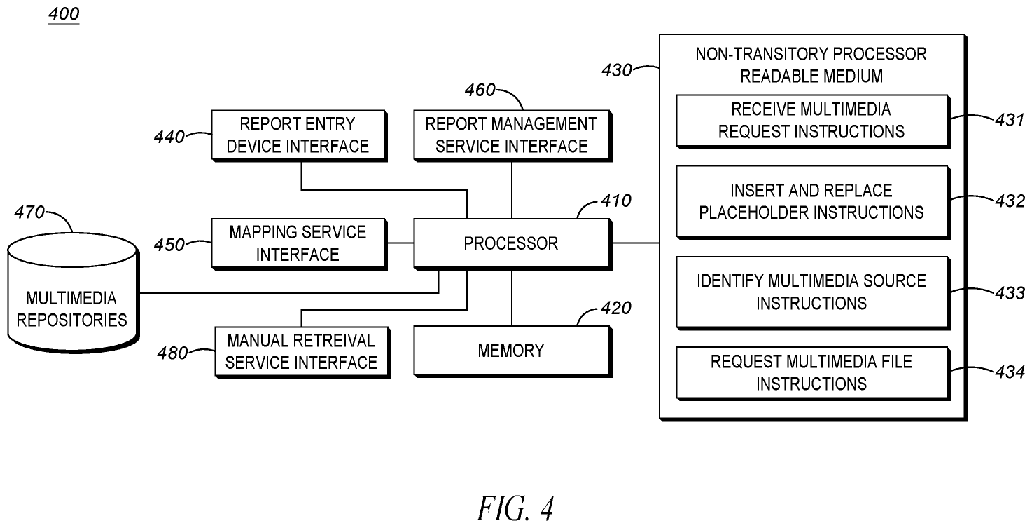

In the description above of FIG. 2, various individual devices and services were described. It should be understood that this was for purposes of ease of description, and not by way of limitation. The various devices and services could be combined in any number of ways. For example, the report entry device 205 may be combined with the radio 226 or any other device. Likewise, the virtual assistant could be combined with any other service, such as the mapping service. Functionality provided by the virtual assistant 215, NLP 216, and mapping service 220 could be moved between any of those entities. What should be understood is that FIG. 2 is described in terms of various pieces of functionality provided rather than being limited to any particular implementation. Furthermore, it should be understood that the description of FIG. 2 is not intended to be limited to any particular hardware implantation. The various pieces of functionality could be implemented on a device such as that described with respect to FIG. 4, on cloud computing devices, or on any combination thereof. The techniques described herein are not limited to any particular hardware implementation.

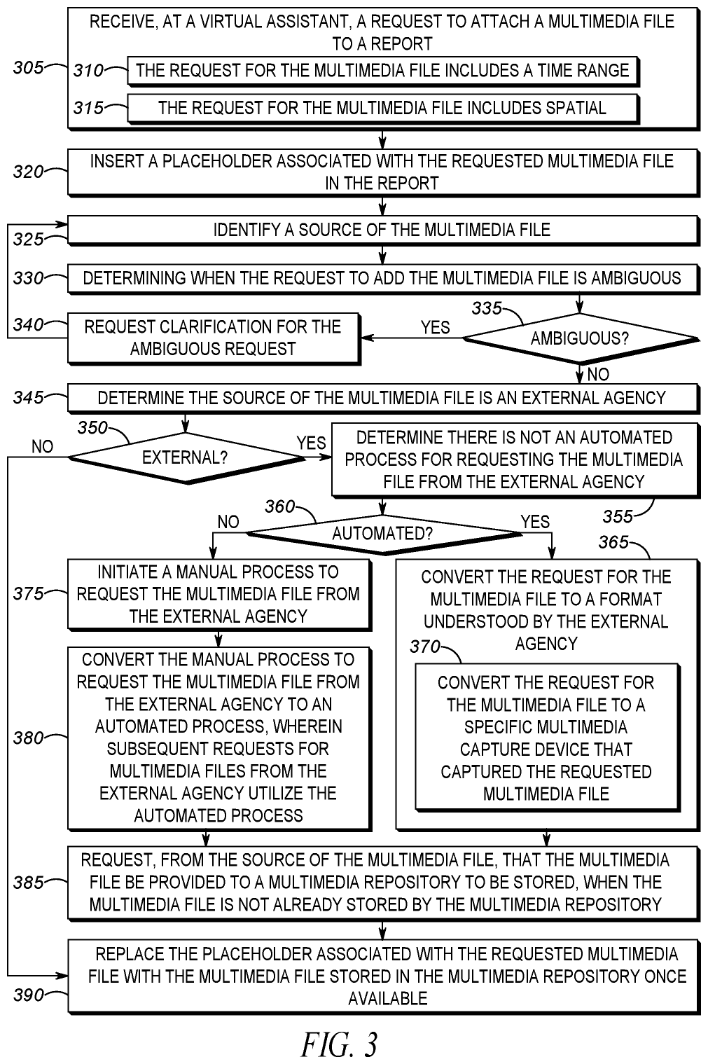

FIG. 3 is an example flow diagram of an implementation of the multimedia management techniques described herein. In block 305, a request to attach a multimedia file to a report may be received at a virtual assistant. As explained above, public safety personnel may be creating an incident report, which may referred to simply as a report, and wish to attach a multimedia file to the report. The request may be made using colloquial language (e.g. attach video from my body worn camera, etc.) as opposed to using technical terminology for file identification (e.g. attach file from BWC serial number 123456, etc.). In some cases, the request for the multimedia file may include a time range (e.g. footage from today, 2:55 PM to 3:10 PM) 310. In some cases, the request for the multimedia file may include spatial information (e.g. front view of the dashboard camera, store security camera whose field of view covers the parking lot, etc.) 315. What should be understood is that the request to the virtual assistant is a user friendly representation of the multimedia file, or portions thereof, that the user wishes to attach to the incident report.

In block 320, a placeholder associated with the requested multimedia file may be inserted into the report. As explained above, the multimedia file may not be immediately available in the multimedia repository for attachment to the report. Rather than have the public safety officer track down the file to attach, the techniques described herein offload this task to the virtual assistant. Once the files are available, they may be attached to the report by the virtual assistant, thus replacing the placeholders. Once all multimedia files have been attached or are determined to be unavailable, the public safety officer can be informed that the attachment of multimedia files is complete.

In block 325, a source of the multimedia file may be identified. One of the advantages of the techniques described herein is that the official creating the report need not worry about the source of the multimedia file. In some cases, the source of the multimedia file may be sources controlled by the agency (e.g. dashboard cameras of agency vehicles, body worn cameras of agency personnel, etc.). In other cases, the source of the multimedia file may be an external public safety agency. In yet other cases, the source of the multimedia files may other municipal agencies that are not public safety agencies. For example, the streets and sanitation department may maintain traffic cameras that capture multimedia files. In yet other cases, the source of the multimedia files may be private sources (e.g. store surveillance cameras, residential doorbell cameras, etc.). The source of the multimedia file may be determined by the virtual assistant to determine how the multimedia file will be retrieved for attachment to the report.

In block 330, it may be determined if the request to add the multimedia file is ambiguous. As described above, the request to add the multimedia file may be made using colloquial language, which may include ambiguity. For example, assume that an agency has two officers with the last name Smith. A request to add the BWC from officer Smith would be ambiguous, because it cannot be determined which officer Smith is being referred to.

In block 335, when it is determined that the request was ambiguous, the process moves to block 340. In block 340, clarification for the ambiguous request may be requested. For example, in the case of the request for Officer Smith's BWC footage, the virtual assistant may respond that there are multiple officers named Smith, and further clarification is required. The person creating the report may then provide additional identifying details (e.g. attach the BWC footage from Officer John Smith, etc.). If it is determined in block 335 that the request is not ambiguous, the process moves to block 345.

In block 345, it may be determined if the source of the multimedia file is an external agency. For purposes of this description, external agency refers to both other public safety agencies, as well as other municipal and private multimedia sources. If it is determined in block 350 that the source of the multimedia file is not an external agency, the process moves to block 390, described in further detail below. As explained with respect to FIG. 2, for multimedia files whose source is the agency creating the report, the location of the file and other details, such as naming convention of the files, would already be known by the virtual assistant by virtue of the virtual assistant being associated with the agency. If it is determined in block 350 that the source of the multimedia file is external to the agency, the process moves to block 355.

In block 355 it is determined if there is not an automated process for requesting the multimedia file from the external agency. As explained above, initially, there may not be an automated process for retrieving a multimedia file from an external agency, and that process may be developed over time. In block 360, if it is determined that there is not an automated process for retrieving the multimedia file from the external agency, the process moves to block 375.

In block 375, a manual process may be initiated to retrieve the multimedia file from the external agency. The manual process may include assigning the task of retrieving the multimedia file to a human in order to engage with the external agency to obtain the requested multimedia file. For example, a human agent may be assigned to call someone at the external agency and request that the multimedia file be sent to be added to the agency multimedia repository. For example, the multimedia file could be emailed to the human agent or a link could be provided to upload the multimedia file to the multimedia repository.

In cases where the request is a one-off request, the manual process for requesting a multimedia file may be sufficient. If there are not repeated requests to the same external agency for multimedia files, it may not make sense to invest the time and effort into creating an application programming interface (API) that may be used to programmatically retrieve multimedia files from the agency. However, if the manual process is invoked often enough, it may be desirable to implement an automated retrieval API.

In block 380, if a determination is made that an automated process should be implemented, the manual process to request the multimedia file from the external agency may be converted to an automated process. Subsequent requests for multimedia files from the external agency may utilize the automated process. Converting the manual process to an automated process may include identifying the storage locations and naming conventions of the external agency such that the colloquial requests to the virtual assistant can be converted to a format understood by the external agency. The process for retrieving a multimedia file from the external agency using an automated technique is describes starting in block 365.

In block 365, the request for the multimedia file is converted to a format understood by the external agency. As explained above, the request to the virtual assistant to attach a multimedia file is made using colloquial language. This colloquial language may need to be converted to a more specific identifier that is used to identify the multimedia file within the external agencies multimedia repository. For example, a request to, “attach officer smith's body worn camera video from today” may be converted to the specific file naming convention used by the external agency. For example, the external agency may store files with a naming convention of officer name-date and the files will be stored in the multimedia repository file folder named BWC. Thus a request for officer smith's BWC video from today could be converted to a request for a file from the BWC directory, title “Smith-18 Apr. 2022” and that is the file that is retrieved.

As yet another example, converting the request for a multimedia file could further comprise converting the request to a specific multimedia capture device. In block 370, the request for the multimedia file may be converted to a specific multimedia capture device that captured the requested multimedia file. For example, the body worn cameras in an external agency may be referred to by their serial numbers. Thus a request for the body worn camera footage from officer Smith may be converted by first determining which body worn camera officer Smith was wearing that day and then determining the serial number of that device. The request for the multimedia file may then refer to the serial number for that specific device.

Although several examples of converting the colloquial request to a format understood by the external agency are described, it should be understood that these are simply examples included for ease of description. What should be understood is that the colloquial request for a multimedia file is converted to a format that can be understood by the external agency. Furthermore, although the conversion is described in terms of accessing multimedia files from an external agency, it should be understood that a similar conversion may be executed within an agency (not shown). However, because the virtual assistant is associated with the agency, it is likely that the virtual assistant is already aware of the naming convention used by the agency and is already aware of how to retrieve multimedia files from the agency's own multimedia repository.

In block 385, it may be requested from the source of the multimedia file, that the multimedia file be provided to a multimedia repository to be stored, when the multimedia file is not already stored by the multimedia repository. As explained above, in cases where the source of the multimedia file is the agency creating the report, the multimedia file will likely already be destined for the agency multimedia repository. However, in the case of an external source, the multimedia file needs to be stored in the agency multimedia repository via either a manual or automated process.

In block 390, the placeholder associated with the requested multimedia file may be replaced with the multimedia file stored in the multimedia repository once available. As explained above, the process of the multimedia file being made available in the multimedia repository may not have a fixed time duration. It could be immediate (e.g. officer uploads BWC video manually, etc.), later the same day (e.g. officer uploads BWC video at end of shift, etc.), or multiple days later (e.g. manual multimedia file retrieval process requires human intervention, etc.). What should be understood is that once the multimedia file is available in the multimedia repository, the multimedia file may be attached to the report. Once all multimedia files have been attached to the report, the report writer can be notified that the report is complete.

FIG. 4 is an example of a device that may implement the managing multimedia upload of a report using a virtual assistant techniques described herein. It should be understood that FIG. 4 represents one example implementation of a computing device that utilizes the techniques described herein. Although only a single processor is shown, it would be readily understood that a person of skill in the art would recognize that distributed implementations are also possible. For example, the various pieces of functionality described above (e.g. virtual assistant, mapping service, etc.) could be implemented on multiple devices that are communicatively coupled. FIG. 4 is not intended to imply that all the functionality described above must be implemented on a single device.

Device 400 may include processor 410, memory 420, non-transitory processor readable medium 430, report entry device interface 440, mapping service interface 450, report management service interface 460, multimedia repositories 470, and manual retrieval service interface 480.

Processor 410 may be coupled to memory 420. Memory 420 may store a set of instructions that when executed by processor 410 cause processor 410 to implement the techniques described herein. Processor 410 may cause memory 420 to load a set of processor executable instructions from non-transitory processor readable medium 430. Non-transitory processor readable medium 430 may contain a set of instructions thereon that when executed by processor 410 cause the processor to implement the various techniques described herein.

For example, medium 430 may include receive multimedia request instructions 431. The receive multimedia request instructions 431 may cause the processor to interact with the report entry device interface 440 to receive a request from a user to attach a multimedia file to a report that is being created. The receive multimedia request instructions 431 are described throughout this description generally, including places such as the description of blocks 305-315.

The medium 430 may include insert and replace placeholder instructions 432. The insert and replace placeholder instructions 432 may cause the processor to insert a placeholder into the report being created via the report management service interface 460 when the multimedia file that has been requested is not yet available for attachment to the report. Once the requested multimedia file is available, the insert and replace placeholder instructions 432 may cause the requested multimedia file to be retrieved form the multimedia repositories 470 and to replace the placeholders in the report via the report management service interface. The insert and replace placeholder instructions 432 are described throughout this description generally, including places such as the description of blocks 320 and 390.

The medium 430 may include identify multimedia source instructions 433. The identify multimedia source instructions 433 may cause the processor to parse the colloquial request for a multimedia file into a standard form and determine from where that multimedia file may be retrieved. For example, the mapping service interface 450 may be used to identify from which multimedia repository 470 the multimedia file may be retrieved from. In some cases, identifying the multimedia source may include initiating a manual process via the manual retrieval service interface 480. The identify multimedia source instructions 433 are described throughout this description generally, including places such as the description of blocks 325-380.

The medium 430 may include request multimedia file instructions 434. The request multimedia file instructions 434 may cause the processor to cause the requested multimedia files to be stored in the multimedia repositories 470 for later inclusion in the report via the report management service interface 460. The request multimedia file instructions 434 are described throughout this description generally, including places such as the description of block 385.

As should be apparent from this detailed description, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot store a multimedia file in a multimedia repository and electronically attach the multimedia file to an electronic report, among other features and functions set forth herein).

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for attaching multimedia to a report comprising:
receiving, at a virtual assistant, a request to attach a multimedia file to a report;
inserting a placeholder associated with the requested multimedia file in the report;
identifying a source of the multimedia file;
requesting, from the source of the multimedia file, that the multimedia file be provided to a multimedia repository to be stored, when the multimedia file is not already stored by the multimedia repository; and
replacing the placeholder associated with the requested multimedia file with the multimedia file stored in the multimedia repository once available.

2. The method of claim 1 further comprising:
determining the source of the multimedia file is an external agency; and
converting the request for the multimedia file to a format understood by the external agency.

3. The method of claim 1 further comprising:
determining the source of the multimedia file is an external agency;
determining there is not an automated process for requesting the multimedia file from the external agency;
initiating a manual process to request the multimedia file from the external agency; and
converting the manual process to request the multimedia file from the external agency to an automated process, wherein subsequent requests for multimedia files from the external agency utilize the automated process.

4. The method of claim 1 further comprising:
determining if the request to add the multimedia file is ambiguous; and
requesting clarification for the ambiguous request.

5. The method of claim 1 further comprising:
converting the request for the multimedia file to a specific multimedia capture device that captured the requested multimedia file.

6. The method of claim 1 wherein the request for the multimedia file includes a time range.

7. The method of claim 1 wherein the request for the multimedia file includes spatial information.

8. A system for attaching multimedia to a report comprising:
a processor; and
a memory coupled to the processor, the memory containing a set of instructions thereon that when executed by the processor cause the processor to:
receive, at a virtual assistant, a request to attach a multimedia file to a report;
insert a placeholder associated with the requested multimedia file in the report;
identify a source of the multimedia file;
request, from the source of the multimedia file, that the multimedia file be provided to a multimedia repository to be stored, when the multimedia file is not already stored by the multimedia repository; and
replace the placeholder associated with the requested multimedia file with the multimedia file stored in the multimedia repository once available.

9. The system of claim 8 further comprising instructions that cause the processor to:
determine the source of the multimedia file is an external agency; and
convert the request for the multimedia file to a format understood by the external agency.

10. The system of claim 8 further comprising instructions that cause the processor to:
determine the source of the multimedia file is an external agency;
determine there is not an automated process for requesting the multimedia file from the external agency;
initiate a manual process to request the multimedia file from the external agency; and
convert the manual process to request the multimedia file from the external agency to an automated process, wherein subsequent requests for multimedia files from the external agency utilize the automated process.

11. The system of claim 8 further comprising instructions that cause the processor to:
determine if the request to add the multimedia file is ambiguous; and
request clarification for the ambiguous request.

12. The system of claim 8 further comprising instructions that cause the processor to:
convert the request for the multimedia file to a specific multimedia capture device that captured the requested multimedia file.

13. The system of claim 8 wherein the request for the multimedia file includes a time range.

14. The system of claim 8 wherein the request for the multimedia file includes spatial information.

15. A non-transitory processor readable medium containing a set of instructions thereon that when executed by a processor cause the processor to:
receive, at a virtual assistant, a request to attach a multimedia file to a report;
insert a placeholder associated with the requested multimedia file in the report;
identify a source of the multimedia file;
request, from the source of the multimedia file, that the multimedia file be provided to a multimedia repository to be stored, when the multimedia file is not already stored by the multimedia repository; and
replace the placeholder associated with the requested multimedia file with the multimedia file stored in the multimedia repository once available.

16. The medium of claim 15 further comprising instructions that cause the processor to:
determine the source of the multimedia file is an external agency; and
convert the request for the multimedia file to a format understood by the external agency.

17. The medium of claim 15 further comprising instructions that cause the processor to:
determine the source of the multimedia file is an external agency;
determine there is not an automated process for requesting the multimedia file from the external agency;
initiate a manual process to request the multimedia file from the external agency; and
convert the manual process to request the multimedia file from the external agency to an automated process, wherein subsequent requests for multimedia files from the external agency utilize the automated process.

18. The medium of claim 15 further comprising instructions that cause the processor to:
determine if the request to add the multimedia file is ambiguous; and
request clarification for the ambiguous request.

19. The medium of claim 15 further comprising instructions that cause the processor to:
convert the request for the multimedia file to a specific multimedia capture device that captured the requested multimedia file.

20. The medium of claim 15 wherein the request for the multimedia file includes a time range.
